(19) United States
(12) Patent Application Publication
(10) Pub. No.: US 2006/0059047 A1
(43) Pub. Date: Mar. 16, 2006

(54) System and method for providing electronic media

(76) Inventors: Gaetano Cardone, Montreal (CA); Domenico Durante, Stouffville (CA); Alessandro Mone, St. Leonard (CA)

Correspondence Address: Blake, Cassels & Graydon LLP, 199 Bay Street, Box 25 , Commerce Court West, Toronto, ON, M5L 1A9, CA

(21) Appl. No.: 11/225,005

(22) Filed: Sep. 14, 2005

Related U.S. Application Data
(60) Provisional application No. 60/609,274, filed on Sep. 14, 2004.

(51) Int. Cl. G06Q 30/00

(52) U.S. Cl. 705/14

(57) ABSTRACT

A system and method for providing electronic media is given. At least one kiosk is remotely located relative to a management portion which governs and controls the operations of the kiosk. The kiosk is connected to the management portion via a network and provides media available through the network using an interactive display. The kiosk also provides a communication display which broadcasts pre-determined auxiliary media content and a static display which provides advertising space. The static display preferably covers the unused portion of the base of the kiosk and the purchasers of the advertising space remunerate the management portion to allow the management portion to provide access to the network free of charge to the user.

### FIELD OF THE INVENTION

The present invention relates generally to electronic media and in particular to a system and method for providing access to electronic media.

### BACKGROUND OF THE INVENTION

With the advent of electronic communication, in particular the Internet and the use of electronic mail (Email), there has developed a growing need and desire to gain access to networks facilitating such electronic communication in a convenient and, most preferably, cost-effective manner.

People who wish to use the Internet or communicate via Email are typically required to do so at home, at work, at a “Pay-Per-Use” Internet establishment or if they have the means to do so, through a personal digital assistant (PDA) or other such Email or wireless computing device. The above mentioned methods for electronic communication can be either expensive or inconvenient when the person is not at home or at work.

The increasing reliance on Internet access by society has made it difficult in some cases to allow basic communication in a convenient and cost effective manner. A person is faced with the challenge of either being required to spend significant amounts of money to equip a wireless device for “on-the-fly communication” or to find a means for accessing the Internet when away from home or work. Furthermore, the Internet is a service which typically must be paid for when access at home is desired and not all occupations provide free Internet access at work.

Therefore there exists a need to provide electronic media services such as Internet access and Email capabilities at no cost to the user. Such a service would allow the use of networks which have become essential in a person's day-to-day activities due to the heavy reliance on wide-spread communication via the Internet to accomplish these day-to-day activities.

It is therefore an object of the present invention to provide a method and apparatus to obviate or mitigate at least some of the above mentioned disadvantages.

### SUMMARY OF THE INVENTION

In one aspect, the present invention provides a kiosk for providing electronic media comprising a base which supports the kiosk; an interactive module supported by the base; the interactive module being controlled by a communication module capable of providing the electronic media using the interactive module; and a display also supported by the base and capable of displaying auxiliary media.

In another aspect, the present invention provides a method for providing electronic media comprising the steps of remotely situating at least one kiosk relative to a server and connecting the kiosk(s) with the server using a communication connection over a network; providing access to the network using an interactive module provided by the kiosk(s); providing auxiliary media on a display provided by the kiosk(s); and monitoring the activity of the kiosk(s) from the server.

In yet another aspect, the auxiliary media provided by the system and method described according to the present invention comprises advertising content.

### BRIEF DESCRIPTION OF THE DRAWINGS

The features of the invention will become more apparent in the following detailed description in which reference is made to the appended drawings wherein:

FIG. 1 is a schematic drawing depicting the elements of an electronic media system.

FIG. 2 is a perspective view of one of the kiosks of FIG. 1.

FIG. 3 is a schematic drawing of the internal components of the kiosk of FIG. 2.

FIG. 4 is a schematic drawing of the network operating centre (NOC) of FIG. 1.

FIG. 5 is a schematic drawing of the administration and production elements of FIG. 1.

FIG. 6 is an example of a web browser interface displayed by the kiosk of FIG. 2.

FIG. 7 is a schematic drawing of a login interface displayed by the kiosk of FIG. 2.

FIG. 8 is a flow diagram depicting the use of the interactive module of FIG. 2.

FIG. 9 is a flow diagram depicting the steps in a self-correcting procedure.

FIG. 10 is a flow diagram depicting the steps in a remote monitoring procedure.

FIG. 11 is a flow diagram depicting the steps in a media synchronisation procedure.

### DETAILED DESCRIPTION OF THE INVENTION

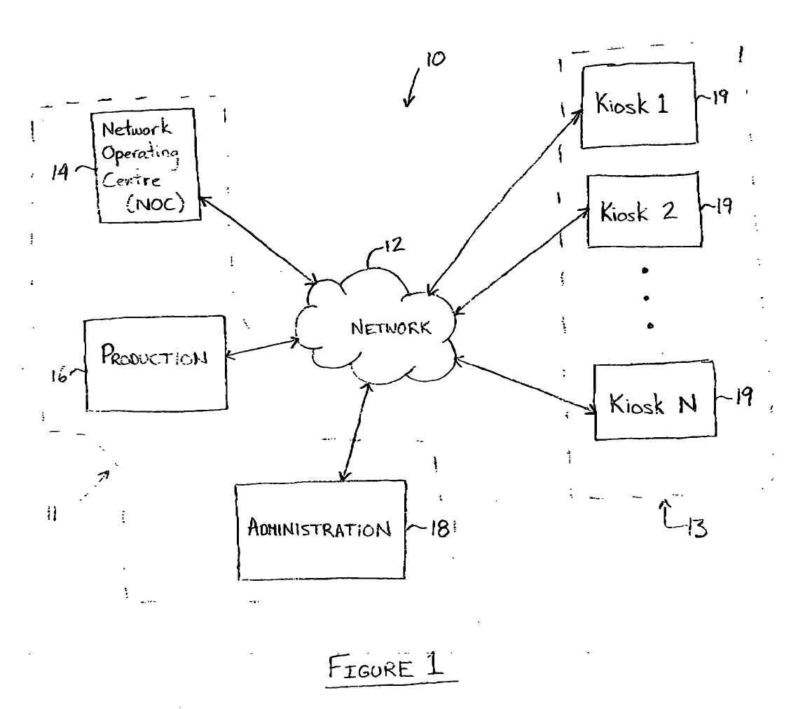

Referring therefore to FIG. 1, an electronic media system is generally denoted by numeral 10. The electronic media system 10 is more specifically comprised of a management portion 11 and a user portion 13. The management portion 11 may be comprised of a single entity but will be herein illustrated as being sub-divided into three entities: a network operating centre (NOC) 14, a production entity 16 and an administration entity 18. It will be appreciated that all of the functionality imparted by each of the elements associated with the management portion 11 may be implemented using any number of entities (E.g. all three accomplished with one entity) and three are shown in this example to better illustrate the fundamental responsibilities of the management portion 11.

The user portion 13 is comprised of at least one kiosk 19. Any number of kiosks 19 may be used as necessary or desired and in this example an arbitrary “N” number of kiosks is shown illustrating that any finite number of kiosks 19 may be utilized by the present invention. Hereinafter the structure and functionality of one kiosk 19 will be explained and it will be appreciated that all kiosks 19 used by the user portion 13 are preferably implemented in a similar manner.

The management portion 11 and user portion 13 are remotely situated relative to each other and are connected to each other through a network 12. Any suitable network for transmitting electronic data is suitable and for the example described herein, and most preferably, an internet protocol (IP) network is used. Other such networks may include but shall not be limited to Intranet, file transfer protocol (FTP) etc.

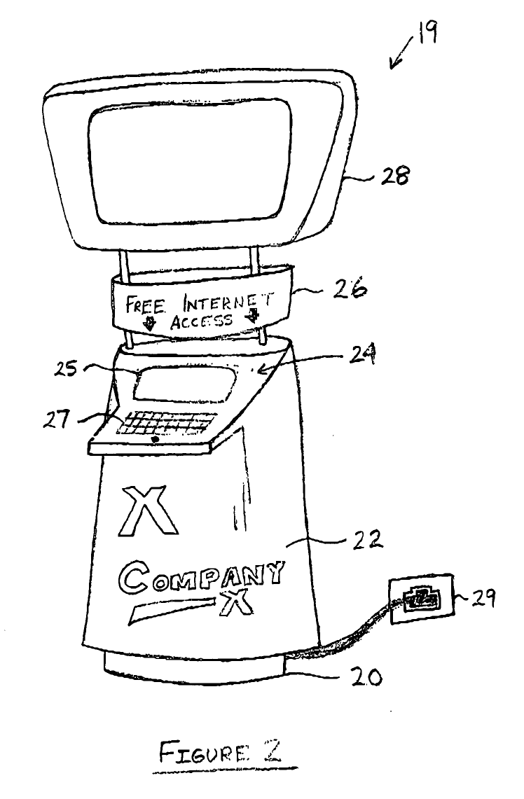

One of the kiosks 19 incorporated in the user portion 13 is shown in FIG. 2. The kiosk 19 includes a base 20 which supports its various elements. Preferably, a static display 22 is affixed to the base. The static display 22 is generally defined by a surface which in this case completely surrounds the base and incorporates the entire lower portion of the kiosk 19. The surface defined by the static display 22 is preferably used to display advertisements pertaining one or many commercial organizations which remunerate the administration entity 18 of the electronic media system 10 for providing these advertisements.

The kiosk 19 also includes an interactive module 24 and in this example the interactive module 24 is mounted atop the static display 22 and base 28 thereby situating it at a height which is comfortable for use. The interactive module 24 further comprises a display screen 25 for viewing electronic media presented by the display screen 25 and an interface device 27 which in this example is a keyboard and “trackball mouse”. It will be appreciated that the interactive module 24 may incorporate any number of devices which allow a user to interact with the display access information. For example a touchscreen may be used wherein the display screen 25 and interface device 27 are incorporated into one multi-use device.

Optionally, the kiosk 19 may also incorporate additional signage 26 which can be used to provide instructions or to incorporate further advertising space etc. This additional signage 26 may be placed in any suitable orientation and in this example is affixed to a set of supports holding a communication display 28 above the interactive display 24. In this example, the communication display 28 is a screen capable of broadcasting a dynamic media “playlist”. Such “playlists” may include video advertisements, banner advertisements, television and/or Internet content etc. Most preferably, the communication display 28 is programmed by the production entity 16 and NOC 14 and operated by the kiosk 19 to provide unattended and automated media broadcasting. The purpose of the communication display 28 is to provide advertising opportunities beyond static advertising posters provided by the static display 22 (E.g. video and/or audio advertising, banners etc.). It will be appreciated that the communication display 28 may incorporate any type of electronic media including visual and auditory media and shall not be limited to any examples referred to herein.

It will also be appreciated that the kiosk 19 described herein is presented for illustrative purposes only. Particularly the various displays (static display 22, additional signage 26 and communication display 28) can be implemented in any arrangement and do not necessarily need to be implemented using three separate structures. The arrangement herein described is preferable, however any arrangement of display(s) which is/are capable of providing auxiliary media in addition to the interactive module 24 can be used. For example, a single display incorporating any or all of the functionality of the communication display 28, static display 22 and additional signage 26 may also be suitable.

The kiosk 19 is connected to the IP network 12 for accessing the IP network 12 and for communicating between itself and the various elements of the management portion 11 during its operation. In this example, the kiosk 19 is connected to an IP network through a standard Ethernet connection 29.

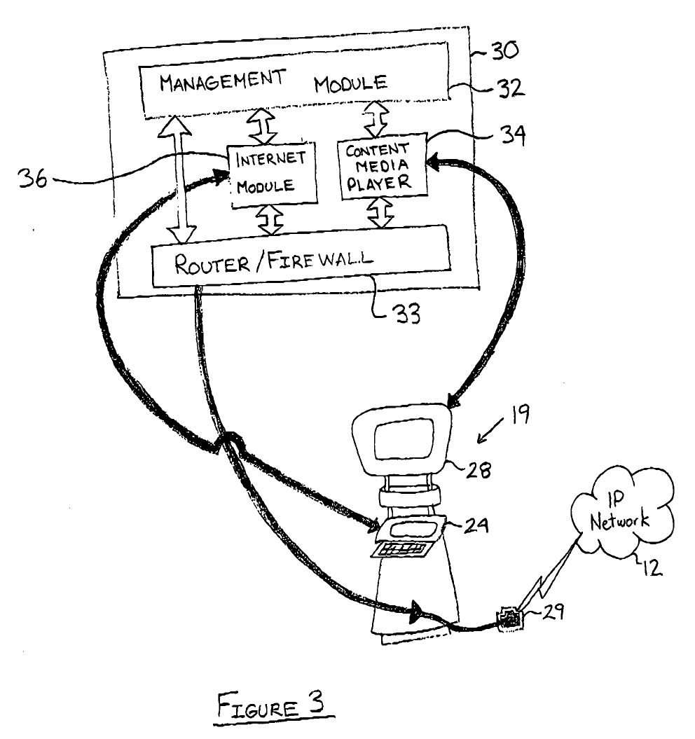

The functionality of the kiosk 19 is internally controlled by a computing device herein referred to as the computing engine 30 shown in FIG. 3. The computing engine 30 preferably contains a set of modules in which each module is responsible for a particular portion of the functionality of the kiosk 19. In this example, these modules include: a management module 32, a content media player 34 and an Internet module 36.

The management module 32 performs tasks such as governing the operations of the kiosk 19 monitoring its activity, checking that the connections are live, and sending alerts to the administration entity 18 when errors arise. The management module 32 is preferably internally connected to the other modules of the computing engine 30 for monitoring purposes and is also connected to the IP network 12 via a router and firewall 33 connected to the Ethernet connection 29 for communication purposes.

The content media player 34 controls the media which is broadcast via the communication display 28. The content media player 34 is connected internally to the communication display 28 for queuing the media, uploading electronic data files and for all other purposes required by the communication display 28 as programmed by the production entity 16 and/or NOC 14. The content media player 34 is also connected externally to the IP network 12 via the router and firewall 33 to allow the production entity 16 and/or NOC 14 to gain access for programming etc.

The Internet module 36 presents the media to a user via the display screen 25 of the interactive module 24. The Internet module 36 is also externally connected to the IP network 12 via the router and firewall 33 to provide Internet access to users of the kiosk 19. It will be appreciated that the Internet module 36 is only named as such for illustrative purposes, however if another type of network such as an Intranet is used, the module would, for example, aptly be named “Intranet module”.

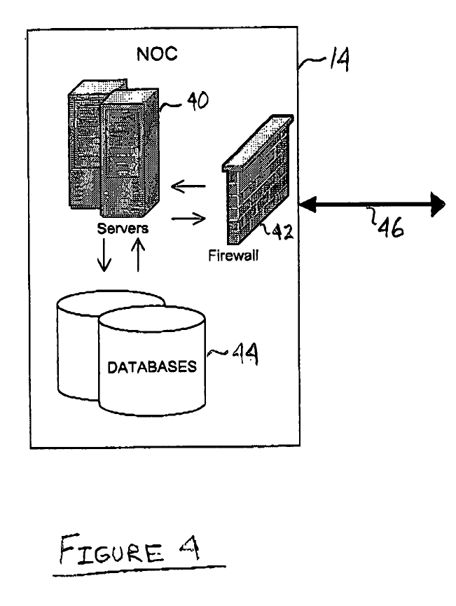

The NOC 14 is shown in FIG. 4. The NOC 14 is the entity which monitors, updates, and communicates with the kiosk 19. The operations performed by the NOC 14 allow each kiosk 19 to be unattended at all times, the exception being when service or maintenance is required. The NOC 14 houses a server 40 which stores information in one or many databases 44. The NOC 14 is connected to the IP network 12 via a suitable communication connection 46 and in this example would preferably be a standard Ethernet connection capable of accessing the IP network 12. Access to the IP network 12 by the server 40 is protected by a firewall 42. The server 40 preferably hosts a website for users of the kiosk 19 to access the free Internet service provided by the kiosk 19.

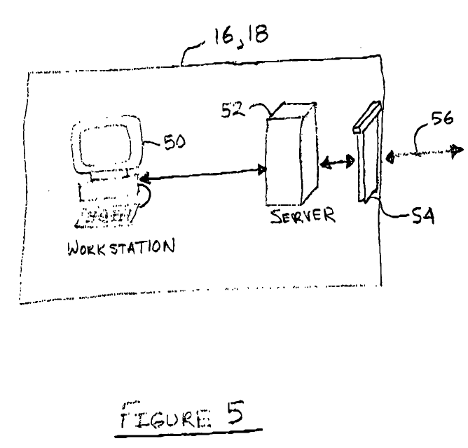

The production entity 16 and administration entity 18 are herein depicted in this example as two separate entities to illustrate the fundamental responsibilities of the management portion 11. The production entity 16 and administration entity 18 can be implemented in a similar manner as shown in FIG. 5. To perform the specified tasks associated with the respective entities, they are generally comprised of a workstation 50, server 52 and a firewall 54 to protect the server 52 when communicating via the network connection 56. It will be appreciated that the elements presented in FIG. 5 describing the production entity 16 and administration entity 18 are given by way of example only to illustrate the preferable configuration for facilitating the operations of these entities.

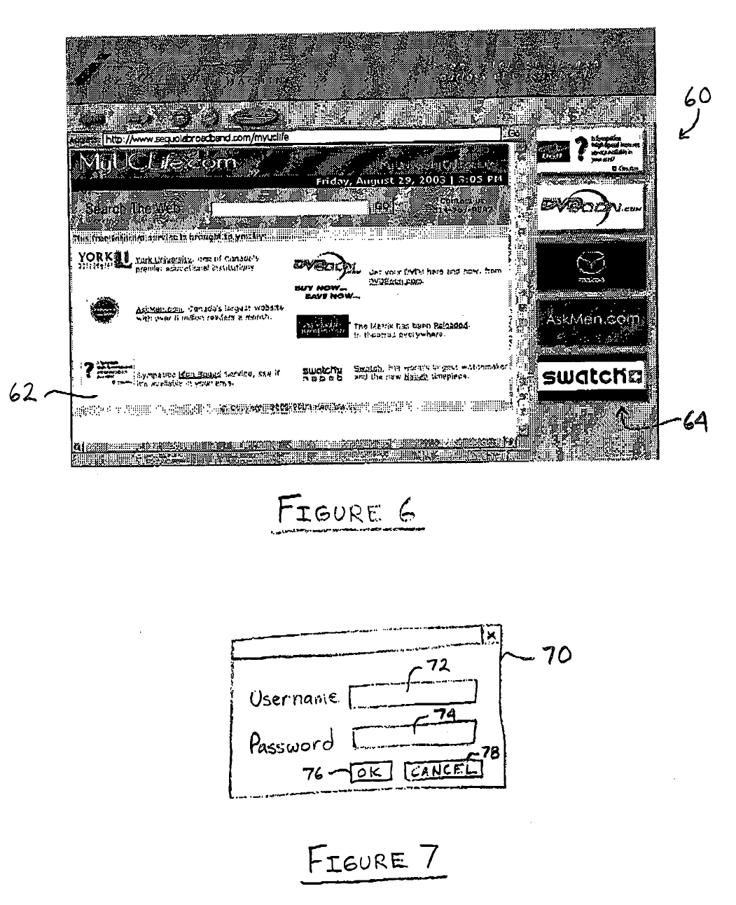

The interactive module 24 as indicated provides a display screen 25 to allow a user to view the electronic media presented. In this example, the electronic media is provided via access to the Internet and an example of a web browser interface 60 is shown in FIG. 6. The web browser 60 allows a user to “surf” the Internet and/or use Email utilities free of charge due to the remuneration to the administration entity 18 from the above mentioned commercial organizations. In a preferable implementation, the web browser 60 will be segmented into a browsing window 62 and an advertisement border 64 which in this example incorporates the left-most portion of the web browser 60. The advertisement border 64 is preferable as another means for presenting advertising content to the user of the kiosk 19 and generating revenue payable to the administration entity 18 to allow access to the IP network 12 free of charge. It will be appreciated that the web browser shown in FIG. 6 is for illustrative purposes only and that any form of web browser can be utilized.

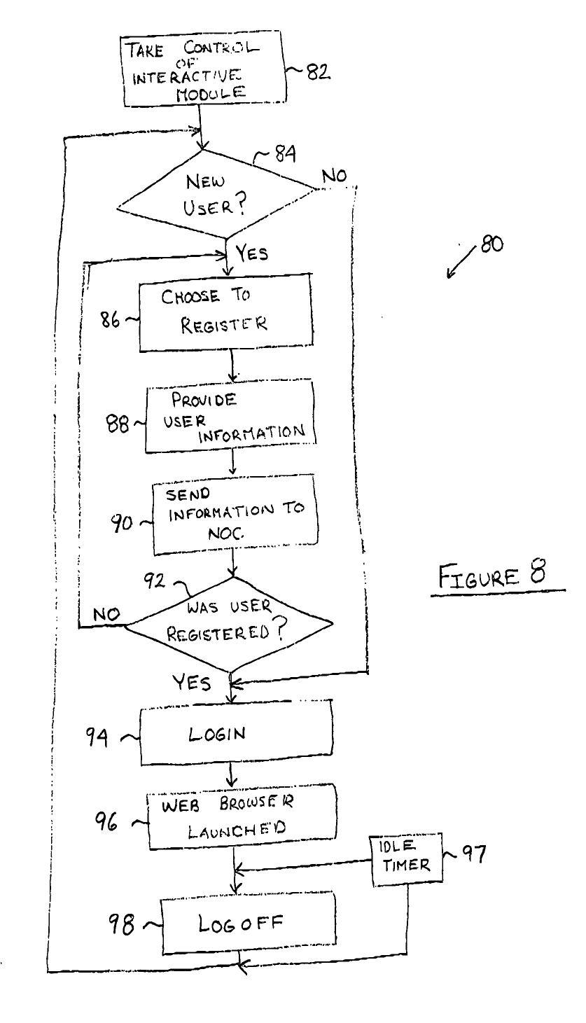

In a preferable implementation of the present invention, to gain access to the web browser 60 and thereby access to the IP network 12, a user may be required to sign up for the free access and in that case would be presented with a login interface 70 as shown in FIG. 7. The login interface 70 allows a user to access the IP network 12 through the input of a username to the username entry box 72 and through input of a password to a password entry box 74. To submit these entries, the user would be required to select the “OK” button 76 or if they wish to exit the login interface 70 they would Select the “Cancel” button 78.

The kiosk 19 is primarily self-sufficient due to the management portion 11 and its coordination and monitoring of activities relating to the kiosk 19. With the electronic media system 10 set up as described above, the kiosk 19 will effectively be operating whether a user is interacting with the kiosk 19 or the kiosk 19 is simply left alone.

When the kiosk 19 has been left alone, in this example it will broadcast electronic media using the communication display 28 and provide static advertising with the static display 22. The communication display 28 can also broadcast a screensaver to attract passers by to the kiosk 19 and may also incorporate advertising content into this screensaver. The static display 22 is preferably a typical advertising poster which conveniently covers a substantial percentage of the lower portion of the kiosk 19. The static display 22 may be of any size suitable and may incorporate any such proportion of the body of the kiosk 19 while in this example (and most preferably) the static display 22 will incorporate the greatest proportion allowable based on the configuration of the kiosk 19. The static display 22 can be updated or interchanged according to any interval as dictated or required by the administration entity 18. Therefore the static display 22 provides a semi-permanent advertisement which targets the users (and passersby) of the kiosk 19 during all hours of the day.

Electronic media is broadcast via the communication display 28 by the content media player 34. The content media player 34 is programmed by one of the elements of the management portion 11 to broadcast various media at various times and for various intervals. It will be understood that the content media player 34 is intended to be flexible and can be programmed to incorporate any type of electronic media thereby creating a “playlist” of specified times to broadcast the electronic media and an associated duration for each “track” in the playlist. A “track” will herein after refer to a media file which is to be broadcast in its entirety and preferably, these tracks are contiguously assembled in a queue to form such a playlist. The content media player 34 stores the tracks and an associated playlist which is typically a set of computer executable instructions for playing the tracks at their specified times and in the specified order. These specified times and the specified order is determined by one of the entities of the management module 11.

The communication display 28 preferably broadcasts the playlists continuously. The playlists may include but shall not be limited to containing music clips, video clips, banner advertisements, screensavers, etc. The content media player 34 runs automatically thereby executing pre-programmed media broadcasts as specified in its playlist. When additional signage 26 is used, it will be appreciated that any advertisements or instructions provided by such additional signage 26 will be statically displayed similar to that of the static display 22.

The kiosk 19 will operate as indicated above without any user interactions and this operation continues when user interaction does occur. The static display 22 remains, as well as the communication display 28 which preferably broadcasts continuously to target people who may not interact with the kiosk 19 using the above mentioned screensaver. When a user interacts with the kiosk 19 it is understood that the purpose of the interaction is to gain free access to the electronic media provided by the IP network 12 and in this example free access to the Internet over an IP network 12.

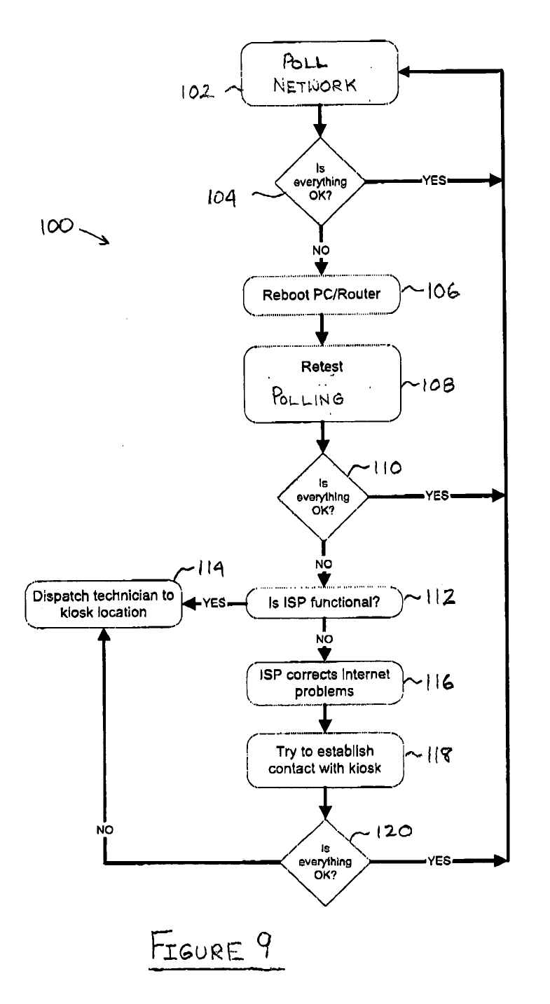

Any person may become a user of the kiosk 19 and access the IP network 12 through the interactive module 24. The general steps which may be taken to use the interactive module 24 are shown in FIG. 8. These general steps will hereinafter be referred to as “web browsing”, denoted by numeral 80. To begin web browsing 80, a person will typically first gain control of the interactive module 82. A person may gain control of the interactive module 82 when the kiosk 19 is unattended or if the kiosk 19 becomes unattended following a queuing process.

It is preferably required that the user be registered with the NOC 14 to access the website hosted by the server 40. The server 40 provides a custom web browser 60 which includes advertisements, custom environments etc. and to gain free access to the IP network 12, the user will preferably gain such access with a user account provided free of charge. Upon gaining control of the interactive module 82, the user will typically be directed in two different direction based on whether or not they are a new user 84. If they are not a new user, they would go directly to logon to the web site 94.

If the person is a new user, they will first choose to register 86. A new user may be required to provide information 88 to be stored by the databases 44. In this example, the user is asked to provide a valid Email address (as a username) and a password. This information is then sent to the NOC 90 via the IP network 12 by accessing the IP network 12 through the Ethernet connection 29. The NOC 14 will file the information in their databases 40 for various purposes. The information is stored for authorizing access to the website hosted by the server 40 and the Email address supplied may also be used as an additional communication tool by the administration entity 18 to provide further advertising or promotional content. It will be appreciated that the information supplied may be comprised of any number of pieces of data and the above mentioned Email address and password are for illustrative purposes only.

The NOC 14 will typically provide a confirmation whether or not the user has been registered 92. If the user was not successfully registered for any reason (Email not valid, already registered, password insufficient etc.) the interactive module 24 will reset to allow the user to attempt to register 86 again. If the user was successfully registered, this confirmation would typically be indicated and the user would be directed to login 94. Upon logging onto the website, the custom web browser is launched 96. In this example, the web browser 60 would resemble that shown in FIG. 6, however it is understood that any suitable interface which allows the user to interact with the IP network 12 can be used,

The user will use the web browser for the time they desire, however a time limit may be enforced to prevent unnecessarily long queues to form at the kiosk 19. When the user is finished, they will logoff 98 and the interactive module 24 will reset to its registration/login page. In this example, an idle timer 97 runs while the user is web browsing 80 to ensure that if a user fails to logoff 98 and a period of inactivity occurs, the interactive module 24 will automatically logoff. During periods of inactivity, the communication display 28 may initiate a screensaver to attract passers by to the kiosk 19 and may incorporate advertising content into such a screensaver.

It will be appreciated that the above web browsing 80 scenario has been provided for illustrative purposes only and that any suitable procedure may be imposed by the interactive module 24 which would allow the user to access the electronic media provided by the IP network 12.

The kiosk 19 as mentioned is intended to operate as a stand alone unit at all hours of the day with little or no human intervention. Preferably, a plasma screen is used for the communication display 28. Plasma screens have a limited shelf life, therefore depending on the hours of operation of the location of the kiosk 19, the communication display 28 can be scheduled to turn off power during the evening and power on again the next morning. For example the communication display may be turned off between the hours of 11:00 p.m. and 7:00 a.m. The communication display will receive instructions to power off from the management module 32 through its connection. A suitable connection an be achieved through an RS-232C serial cable which allows such instructions to be transmitted.

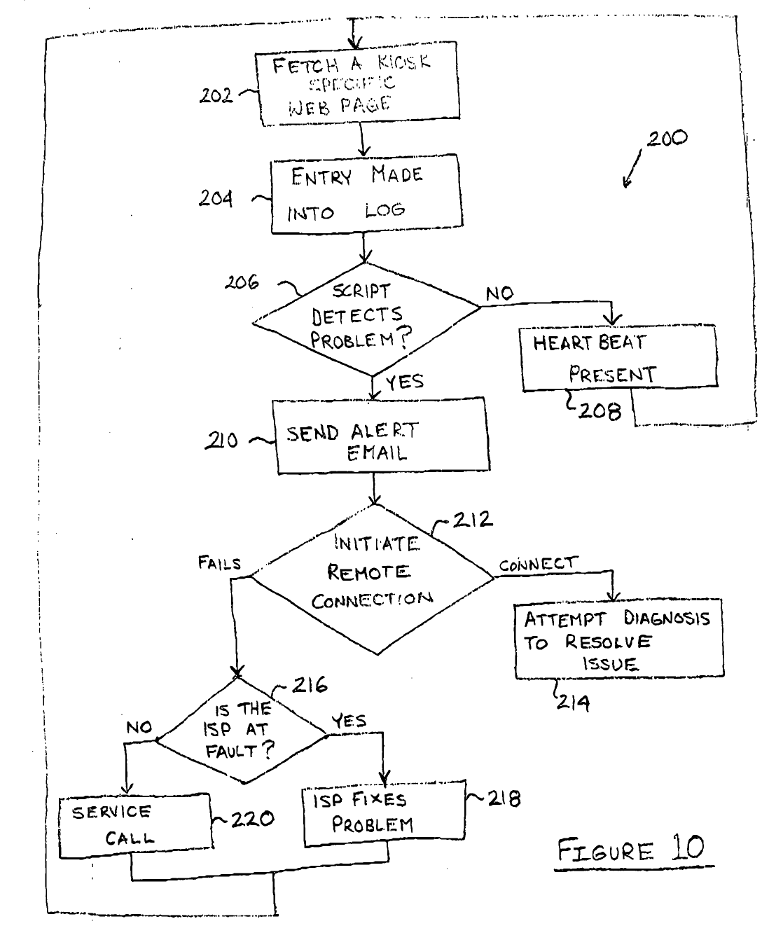

To ensure that the service provided by the kiosk 19 is optimal, there are various procedures enacted by the kiosk 19 and the management portion 11. One such procedure is a self-correcting procedure 100 performed by the kiosk 19, shown in FIG. 9. The management module 32 of the kiosk 19 is suitable for hosting the self-correcting procedure 100. The self-correcting procedure 100 is a routine that attempts to communicate with the IP network 12 on a regular basis. An error in such an attempt is intended to provoke several self-correcting actions such as a reboot. It is understood that the self-correcting procedure 100 described herein is intended to present a preferable routine and the specific details (E.g. number of websites polled, length of interval etc.) are presented for illustrative purposes only.

The management module 32 runs a substantially continuous routine which polls websites 102 to establish whether or not these websites can be accessed thus a connection to the IP network 12 is alive. For example, four websites may be polled every two minutes. During these polling operations, the management module 32 determines whether or not everything is “OK” 104. If the polling has been successful, the management module 32 will continue polling 102. If the polling experiences difficulties, a reboot is attempted 106. The reboot may include rebooting the computing engine 30 or simply just the router and firewall 33, or both. Upon completion of the reboot 106, a retest is done 108 to determine whether or not regular polling can continue. The management module 32 will check whether or not everything is “OK” pertaining to the retest 110. If the retest is successful, regular polling can continue 102. If the retest was unsuccessful a second tier of self correction is attempted.

The first measure taken is to contact the IP network provider and in this example, the internet service provider (ISP) to determine whether or not the service is functional 112. Other checks may occur at this point including but not limited to determining whether electrical power has been interrupted, a plug removed etc. This can occur if a relationship has been established between the administration entity 18 and the establishment which hosts the kiosk 19. If it is determined that the ISP is functional, then the problem is assumed to be internal to the kiosk 19 and the administration entity 18 is contacted and a technician may be dispatched to the kiosk's location 114. If the ISP's service is not functional, a period of “down time” will occur 116 while the ISP fuses their problem.

The management module 32 will not return to regular functionality until contact is once again established with the kiosk 19 by the administration entity 118. The administration entity 18 is capable of polling the kiosk 19 and this procedure will be described below. The management module 32 will determine whether or not everything is “OK” based on whether or not they have resumed contact 120. If the connection has been reestablished, the regular polling resumes 102. If the connection is not restored within a certain amount of time (or based upon any other suitable criteria), a technician will be dispatched to the kiosk's location 114 and the administration entity 18 would typically be contacted at this point.

It will be appreciated that the means for dispatching the technician and contacting the administration entity 18 can be implemented in any suitable manner based on the relationship between the establishment hosting the kiosk 19 and the administration entity 18 and/or the presence of other infrastructure which can be used in the event that the IP network's service experiences “down time”.

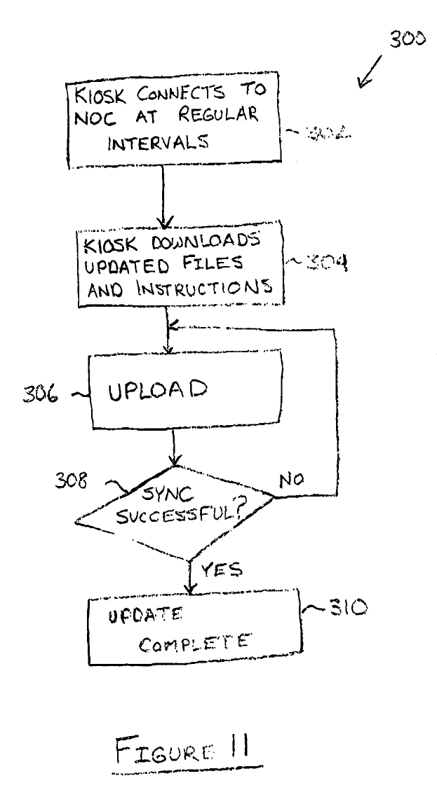

The administration entity 18 may periodically wish to monitor the activity of a kiosk 19. The above described self-correcting procedure 100 may issue an alert to the administration entity 18 via Email which reports that the kiosk 19 is experiencing difficulty in accessing the IP network 12. In addition to self-correction, the kiosk 19 and the administration entity 18 will periodically attempt to indicate that a valid connection exists between the two entities which will hereinafter be referred to as the “kiosk heartbeat” 200. The kiosk heartbeat 200 is shown in FIG. 10. The purpose of the kiosk heartbeat 200 is to allow the administration entity 18 to monitor a log which records the kiosk heartbeats 200. This log is preferably stored by the server 40 at the NOC 14 and is accessible by the administration entity 18.

Preferably, the kiosk 19 will periodically run a component provided by the management module 32 which simulates a web browser request to the server 52 and attempt to read a kiosk-specific web page 202. This process requires the kiosk 19 to access the server 52 provided by the administration entity 18. The server 52 contains a log of kiosk heartbeats 200 for each kiosk 19 which is connected to the IP network 12. When the kiosk 19 accesses the server 52, an entry is made into the log 204. A script run by the server 52 monitors the log and checks that the appropriate entries have been made 206. If a problem has not been detected, a heartbeat is present 208 and the script determines that the kiosk 19 is properly communicating at this time and the process can repeat at the next interval. It will be appreciated that the log may be checked at any interval desired as long as the script can identify missing heartbeats when they occur.

If a problem is detected by the script, the server 52 sends an Email alert 210 to an administrator who may receive this alert at their workstation 50. This alert will indicate that a heartbeat is missing from a particular kiosk 19. Upon receiving such an alert, the administration entity 18 may initiate a remote connection 212. Preferably, there are two types of remote connections which may be made to the kiosk 19 for diagnosis purposes. The first type of connection is a command line based connection which is not perceptible by a user interacting with the kiosk 19. The second type of connection takes control of the interaction module 24 preventing users from interacting with the kiosk 19. A virtual network connection (VNC) is a suitable method for the second type of connection.

If the administration entity 18 is able to connect to the kiosk 19, a connection to the IP network 12 is live and therefore a diagnosis of the machine can be attempted 214. Typically if the connection can be made, the heartbeat may be missing due to such reasons as the kiosk 19 being unavailable due to a self-reboot or that the actual heartbeat component is malfunctioning. It will be appreciated that at this point, any suitable means for resolving the issues raised during the diagnosis can occur such as uploading or downloading information or defective files etc.

If the administration entity 18 is unable to connect to the kiosk 19, a live connection to the IP network 12 is not present. Similar to that of the self-correcting procedure 100, it is determined through any suitable means whether or not there is a problem with the ISP 216. If there is a problem, the ISP will fix their problem 218 and the procedure 200 will begin again. If the ISP is not at fault, the kiosk 19 may be inoperable due to hardware problems or power failure etc. and a service call is made 220 to dispatch a technician to the kiosk's location. Upon repair, the procedure 200 can begin again.

The communication display 28 broadcasts media, executed using a pre-programmed playlist. These playlists are programmed by the management portion 11 of the electronic media system 10 and, more specifically in this example, are programmed by either the production entity 16 or the NOC 14, or both. Playlist programming will hereinafter be referred to as media synchronization 300. The media synchronization may be performed on a kiosk by kiosk basis to tailor the play list to that particular kiosk. In this manner, targeted media can be provided to suit the particular kiosk and its likely users. A typical media synchronization procedure 300 is shown in FIG. 11. Media synchronization 300 can include but shall not be limited to deleting tracks, adding tracks, updating tracks etc.

In this example we will assume that the original playlist has been programmed by the NOC 14 and is currently hosted by the kiosk 19. The media synchronization 300 is, in this example, thereinafter also performed by the NOC 14. The NOC 14 governs the content and broadcasting elements of the media. The NOC 14 as described can access the IP network 12 which allows them to perform the media synchronization 300. In order to perform a media synchronization 300, instructions would typically be given as to the nature of the update. The kiosk 19, using the management module 32, connects to the NOC 14 at regular intervals 302. At this point the kiosk 19 looks in an assigned location for up date data and the kiosk 19 will download the data which may include files to be added and/or a set of update instructions 304. Downloading can be done using any suitable method such as a VNC or file transfer protocol (FTP) etc.

The kiosk 19 will then upload information 306 to the NOC 14 such as status reports, usage statistics etc. for use by the administration entity 18. The administration entity 18 can access this information at any time by connecting to the server 40 at the NOC 14. The kiosk 19 will then determine whether or not the information synchronization was successful 308. If the synchronization was not successful, the kiosk 19 will then reattempt the upload 306. If the synchronization was successful, an message is received from the management module 32 that the update has been completed 310.

Accordingly, the present invention provides a system for providing Internet access to a user of a kiosk 19 free of charge. To pay for the service provided, various business organizations can purchase advertising space either on the static display 22, through the interactive module 24, on the additional signage 26 as well as more advanced advertising to be broadcast by the communication display 28. The system described herein is at the focal point of a partnership trilogy between the vendors where the kiosks are locate, the users of the kiosk 19 (typically consumers of the locations) and business organizations who sponsor the trilogy through paid advertising. The system brings together the parties involved in the trilogy by providing the kiosk and its functionality.

The vendors are remunerated for providing the kiosk 19 both financially from the administration and through exposure to consumers wishing to access the IP network 12 free of charge. The corporate sponsors are able to target specific consumers based on the vendor locations in which they purchase the advertising space and remunerate the administration for their overhead plus the additional expense of paying for access to the IP network 12. The corporate sponsors also become associated with a free service, which brings a perceived benefit. The advertisements may be perceived as beneficial as opposed to intrusive to the consumer since they are also providing the free service. The consumers ultimately benefit from this trilogy through fee access to the IP network while being exposed to advertisements such as promotional offers etc. as well as important information such as news, sports, trivia etc. which may be of interest to them.

Although the invention has been described with reference to certain specific embodiments, various modifications thereof will be apparent to those skilled in the art without departing from the spirit and scope of the invention as outlined in the claims appended hereto.

The embodiment of the invention in which an exclusive property or privelage is claimed are defined as follows:

1. A kiosk for providing electronic media comprising a base, said base supporting said kiosk; an interactive module, said interactive module supported by said base, said interactive module controlled by a communication module capable of providing said electronic media using said interactive module; and a display, said display supported by said base and capable of providing auxiliary media.

2. A kiosk according to claim 1 wherein said auxiliary media comprises advertising content.

3. A method for providing electronic media comprising the steps of remotely situating at least one kiosk relative to a server and connecting said at least one kiosk with said server using a communication connection over a network, providing access to said network using an interactive module provided by said at least one kiosk, providing auxiliary media on a display provided by said at least one kiosk, and monitoring the activity of said at least one kiosk from said server.

4. A method according to claim 3 wherein said auxiliary media comprises advertising content, said advertising content being purchased by a third party thereby paying for said access to said network and allowing said media to be provided by said kiosk free of charge.
